(19) United States
(12) Patent Application Publication
(10) Pub. No.: US 2023/0009861 A1
(43) Pub. Date: Jan. 12, 2023

(54) IMAGE PROCESSING DEVICE AND METHOD OF IMAGE PROCESSING

(71) Applicant: Socionext Inc., Kanagawa (JP)

(72) Inventor: Tsuyoshi HIGUCHI, Yokohama (JP)

(21) Appl. No.: 17/858,578

(22) Filed: Jul. 6, 2022

(30) Foreign Application Priority Data
Jul. 9, 2021 (JP) 2021-114088

(51) Int. Cl. H04N 9/64; H04N 9/04; G06T 7/90

(52) U.S. Cl. CPC H04N 9/64; H04N 9/04515; G06T 7/90; G06T 2207/10024

(57) ABSTRACT

An image processing device includes a memory, and a processor configured to execute obtaining image data from an imaging device in which pixel groups of multiple colors are repeatedly arranged, each of the pixel groups including multiple pixels; and determining a direction in which change in a pixel value is small at a position of a target pixel group, based on a changed amount of the pixel values of at least one of pairs of pixels that are arranged around the target pixel group, and included in multiple other pixel groups having colors that are different from a color of the target pixel group.

### CROSS-REFERENCE TO RELATED APPLICATIONS

The present application is based upon and claims the benefit of priority under 35 U.S.C. § 119 of Japanese Patent Application No. 2021-114088 filed on Jul. 9, 2021, the entire contents of which are hereby incorporated by reference.

### TECHNICAL FIELD

The present disclosure relates to an image processing device and a method of image processing.

### BACKGROUND ART

Image sensors that have a pixel arrangement referred to as QBC (Quad Bayer Coding), in which pixels are arranged as a pixel group of two vertical pixels by two horizontal pixels including one red pixel R, two green pixels G, and one blue pixel B of a Bayer arrangement, have been known. Also, image sensors that include, in addition to pixels of R, pixels of G, and pixels of B, pixels of a color other than R, G, and B, have been known. Also, in the case of converting image data obtained with this type of image sensor to image data of a Bayer arrangement, a method of executing an interpolation process using the pixel values of pixels around a target pixel has been known.

### RELATED ART DOCUMENTS

### Patent Documents

### [Patent Document 1] WO No. 2020/246129

### [Patent Document 2] WO No. 2020/138466

### [Patent Document 3] Japanese Laid-Open Patent Application No. 2020-025305

### [Patent Document 4] Japanese Laid-Open Patent Application No. 2017-158162

### [Patent Document 5] Japanese Laid-Open Patent Application No. 2019-106576

### [Patent Document 6] Japanese Laid-Open Patent Application No. 2011-259060

For example, in the case of interpolating a pixel value, a direction in which change in a pixel value is small is determined, and based on the determination result, pixels to be used for interpolation are determined. However, in the case where the determination of the direction is not appropriate, a figure that is not present in the original image (artifact) may be generated. In order to suppress generation of artifacts, it is important to appropriately determine a direction in which change in the pixel value is small.

### SUMMARY

According to an embodiment in the present disclosure, an image processing device includes a memory, and a processor configured to execute obtaining image data from an imaging device in which pixel groups of multiple colors are repeatedly arranged, each of the pixel groups including multiple pixels; and determining a direction in which change in a pixel value is small at a position of a target pixel group, based on a changed amount of the pixel values of at least one of pairs of pixels that are arranged around the target pixel group, and included in multiple other pixel groups having colors that are different from a color of the target pixel group.

### BRIEF DESCRIPTION OF DRAWINGS

FIG. 1 is a schematic diagram illustrating an example of an image processing system that includes an image processing device according to a first embodiment;

FIG. 2 is a block diagram illustrating an example of a functional configuration of the image processing device in FIG. 1;

FIG. 3 is a block diagram illustrating an overview of a configuration of various devices installed in a mobile body in FIG. 1;

FIG. 4 is a block diagram illustrating an example of a configuration of the image processing device and an information processing device in FIG. 3;

FIG. 5 is an explanatory diagram illustrating an example of converting image data of a QBC arrangement obtained by an imaging device in FIG. 3 to image data of a Bayer arrangement;

FIG. 6 is a flow chart illustrating an example of a processing flow of converting image data of a QBC arrangement to image data of a Bayer arrangement, executed by the image processing device in FIG. 3;

FIG. 7 is an explanatory diagram illustrating an example of a process executed at Step S12 in FIG. 6;

FIG. 8 is an explanatory diagram illustrating another example of a process executed at Step S12 in FIG. 6;

FIG. 9 is an explanatory diagram illustrating an example of a process executed at Step S13 in FIG. 6;

FIG. 10 is an explanatory diagram illustrating another example of a process executed at Step S13 in FIG. 6;

FIG. 11 is an explanatory diagram illustrating an example of processing executed at Steps S20 and S30 in FIG. 6;

FIG. 12 is a flow chart illustrating an example of a processing flow of converting image data of a QBC arrangement to image data of a Bayer arrangement, executed by an image processing device according to a second embodiment;

FIG. 13 is an explanatory diagram illustrating an example of a process executed at Step S14 in FIG. 12;

FIG. 14 is an explanatory diagram illustrating an example of processing executed at Steps S15 and S16 in FIG. 12;

FIG. 15 is a flow chart illustrating an example of a processing flow of converting image data of a QBC arrangement to image data of a Bayer arrangement, executed by an image processing device according to a third embodiment; and

FIG. 16 is a flow chart illustrating an example of a processing flow of converting image data of a QBC arrangement to image data of a Bayer arrangement, executed by an image processing device according to a fourth embodiment.

### EMBODIMENTS OF THE INVENTION

In the following, embodiments will be described with reference to the drawings. In the following description, image data may be simply referred to as an image.

According to the disclosed techniques, a direction in which change in the pixel value is small from image data obtained by an imaging device in which pixel groups of multiple colors each including multiple pixels, are repeatedly arranged, can be appropriately determined.

### First Embodiment

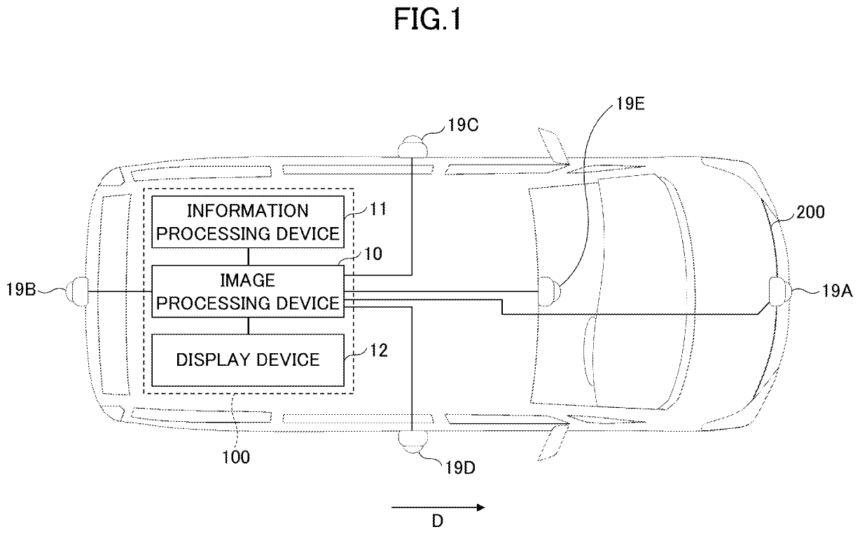

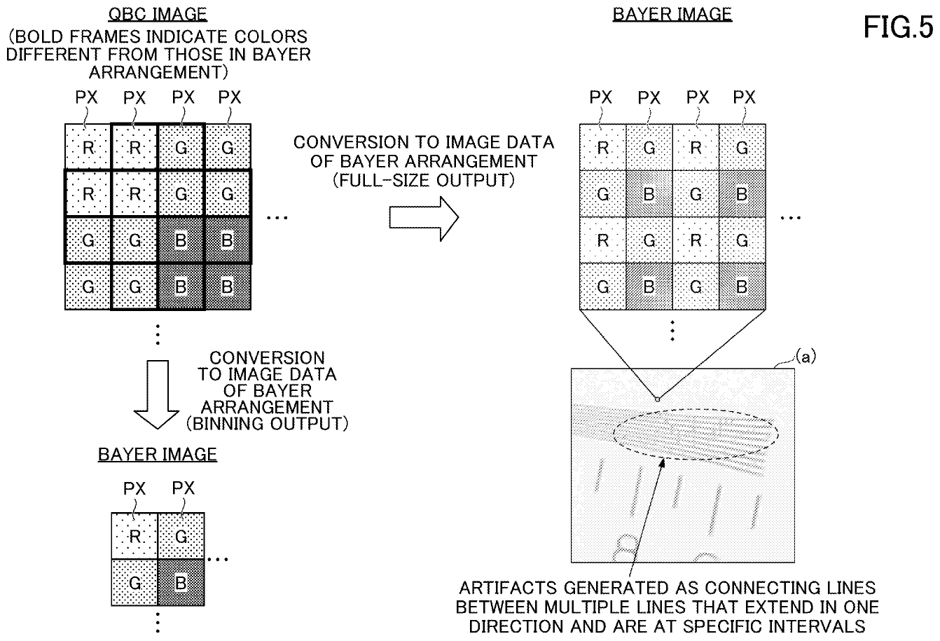

FIG. 1 illustrates an example of an image processing system that includes an image processing device according to the first embodiment. The image processing system 100 illustrated in FIG. 1 is installed in a mobile body 200 such as an automobile or the like. On the front, rear, left, and right sides with respect to a traveling direction D of the mobile body 200, and in the front of the vehicle interior of the mobile body 200, imaging devices 19A, 19B, 19C, 19D, and 19E such as cameras are installed. In the following, in the case where the imaging devices 19A, 19B, 19C, 19D, and 19E do not need to be described distinctively, these imaging devices may be referred to as the imaging device(s) 19. An example of pixels of an image sensor installed in the imaging device 19 will be described with FIG. 5.

Note that the number of the imaging devices 19 installed in the mobile body 200 and their installation positions are not limited as illustrated in FIG. 1. For example, one imaging device 19 may be installed only on the front side of the mobile body 200, or two imaging devices 19 may be installed only on the front and rear sides. Alternatively, the imaging device 19 may be installed on the ceiling of the mobile body 200.

Also, the mobile body 200 in which the image processing system 100 is installed is not limited to an automobile, and may be, for example, a transfer robot operating in a factory, or a drone. Also, the image processing system 100 may be a system that processes images obtained from an imaging device 19 other than the imaging device 19 installed in the mobile body 200, for example, a monitoring camera, digital still camera, digital camcorder, or the like.

Each of the imaging devices 19 is connected to the image processing device 10 by wire or by radio. Also, the distance between each of the imaging devices 19 and the image processing device 10 may be greater than a distance as imagined with FIG. 1. For example, image data obtained by the imaging device 19 may be transmitted to the image processing device 10 installed outside the mobile body 200, via a network. In this case, at least one of the image processing devices 10 and an information processing device 11 may be implemented by cloud computing.

The image processing system 100 includes the image processing device 10, the information processing device 11, and a display device 12. Note that in FIG. 1, in order to make the description easier to understand, the image processing system 100 is illustrated to overlap a schematic diagram of the mobile body 200 as viewed from above. However, in practice, the image processing device 10 and the information processing device 11 are mounted on a control board installed in the mobile body 200, and the display device 12 is installed at a position within the mobile body 200 that is visible to a person such as a driver. Note that the image processing device 10 may be mounted on the control board or the like as part of the information processing device 11.

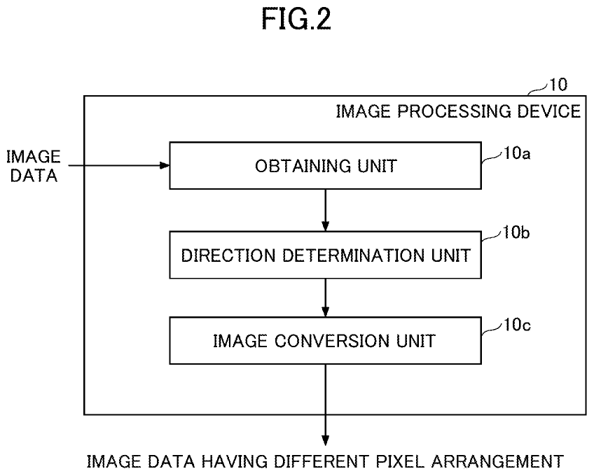

FIG. 2 illustrates an example of a functional configuration of the image processing device 10 in FIG. 1. The image processing device 10 includes an obtaining unit 10a, a direction determination unit 10b, and an image conversion unit 10c. The obtaining unit 10a executes an obtaining process of obtaining image data representing an image around the mobile body 200 captured by each imaging device 19. Here, the imaging device 19 includes an image sensor in which pixel groups of multiple colors are repeatedly arranged wherein each pixel group includes multiple pixels. The image sensor outputs obtained image data to the image processing device 10. For example, the image sensor may have pixels of a QBC arrangement.

Based on a changed amount of the pixel values of at least one of pairs of pixels that are arranged around a target pixel group, and included in multiple other pixel groups having colors that are different from the colors of the target pixel group, the direction determination unit 10b executes a direction determination process of determining a direction in which change in the pixel value is small at the position of the target pixel group. For example, the direction in which change in the pixel value is small is a direction along an edge as a boundary portion of the image at which the brightness changes significantly in an image obtained by the imaging device 19.

Based on the direction determined by the direction determination unit 10b, the image conversion unit 10c replaces at least one of the pixels of the target pixel group with a pixel value of a pixel in another color. Then, the image conversion unit 10c converts the image data obtained by the imaging device 19 to image data having a pixel arrangement that is different from the pixel arrangement of the imaging device 19, and outputs the converted image data. The image data output by the image conversion unit 10c may be output as a result of image processing to at least one of the display devices 12 and the information processing device 11.

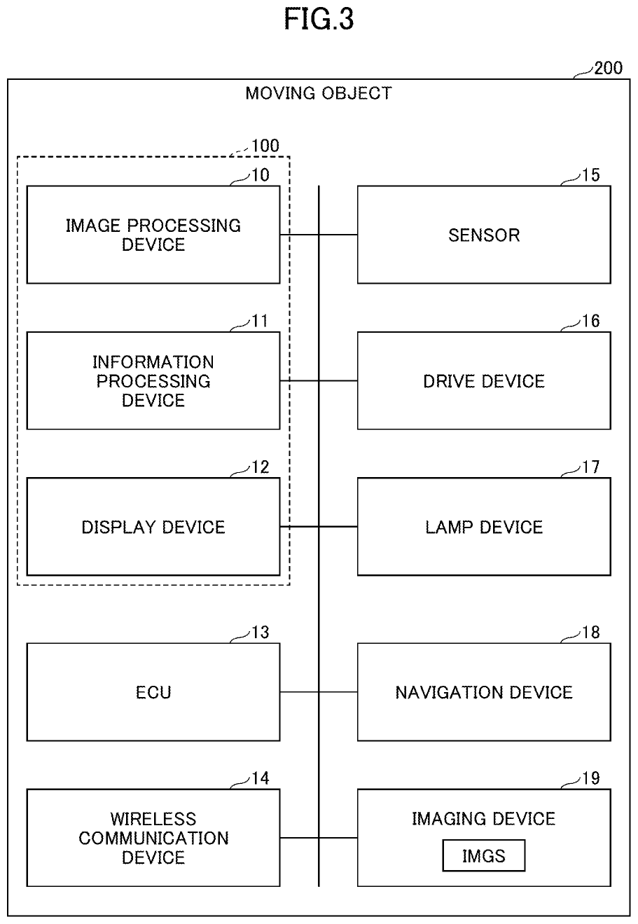

FIG. 3 illustrates an overview of a configuration of various devices installed in the mobile body 200 in FIG. 1. The mobile body 200 includes the image processing device 10, the information processing device 11, the display device 12, at least one ECU (Electronic Control Unit) 13, and a wireless communication device 14 that are interconnected through an internal network. The mobile body 200 also includes a sensor 15, a drive device 16, a lamp device 17, a navigation device 18, and an imaging device 19. For example, the internal network is an in-vehicle network such as a CAN (Controller Area Network), Ethernet (registered trademark), or the like.

The image processing device 10 receives image data (frame data) obtained by the imaging device 19, and executes image processing using the received image data. The information processing device 11 executes processing such as image recognition using the image data to which the image processing has been applied by the image processing device 10. For example, based on an image generated by the image processing device 10, the information processing device 11 may recognize an object such as a person, a signal, and a sign outside the mobile body 200, and may track the recognized object. The information processing device 11 may function as a computer that controls the units of the mobile body 200. Also, the information processing device 11 may control the ECU 13, to control the entire mobile body 200.

The display device 12 displays an image, a corrected image, or the like, using image data generated by the image processing device 10. The display device 12 may display an image in the backward direction of the mobile body 200 in real time as the mobile body 200 travels backward (backs up). Also, the display device 12 may display an image output from the navigation device 18.

The ECU 13 is provided corresponding to each mechanical unit such as an engine or transmission. The ECU 13 controls a corresponding mechanical unit based on instructions from the information processing device 11. The wireless communication device 14 communicates with a device external to the mobile body 200. The sensor 15 is a sensor to detect various types of information. The sensor 15 may include, for example, a position sensor to obtain current positional information of the mobile body 200. Also, the sensor 15 may include a speed sensor to detect the speed of the mobile body 200.

The drive device 16 includes various devices for moving the mobile body 200. The drive device 16 may include, for example, an engine, a steering gear (steering), and a braking device (brake). The lamp device 17 includes various lighting devices installed in the mobile body 200. The lamp device 17 may include, for example, a headlight (headlamp), lamps of a direction indicator (blinker), a backlight, and a brake lamp. The navigation device 18 is a device to guide a route to a destination by sound and display.

The imaging device 19 includes an image sensor IMGS that has pixels installed in a QBC pixel arrangement, where the pixels include multiple types of filters that transmit, for example, red light R, green light G, and blue light B. In other words, the image sensor IMGS includes multiple types of pixels where the types are different from one another in the wavelength range of light to be detected.

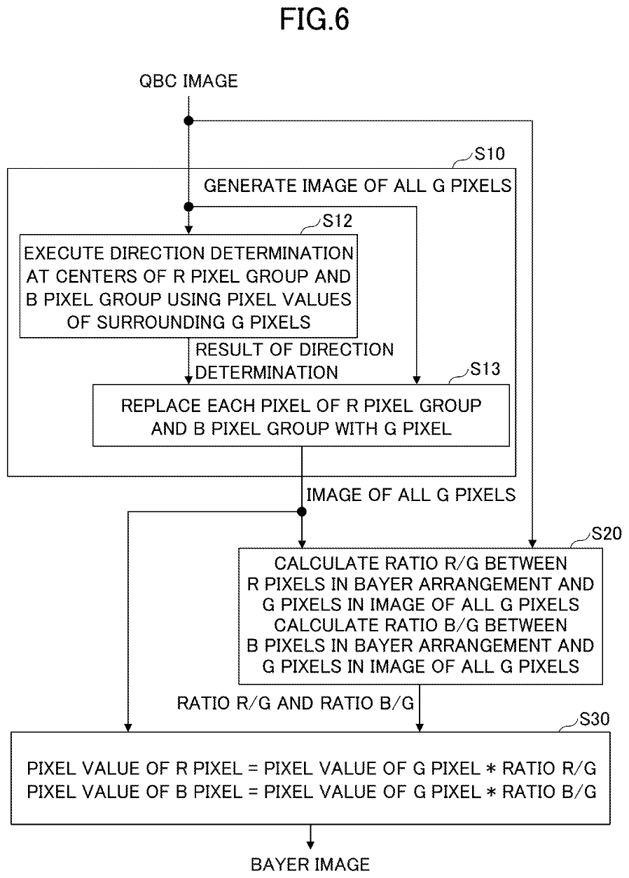

As described above, image data obtained by the imaging device 19 is processed by the image processing device 10. For example, the image processing device 10 corrects (interpolates) the image data obtained by the image sensor IMGS having the QBC pixel arrangement, to generate image data of a Bayer arrangement. The image processing executed by the image processing device 10 will be described with FIGS. 6 to 11.

Note that the imaging device 19 may include an image sensor having a pixel arrangement similar to the QBC, in which pixel groups each including multiple pixels of the same color are arranged repeatedly to be interposed between pixel groups including pixels of the other colors. Also, the image processing device 10 may convert image data obtained by the imaging device 19 to image data other than the Bayer arrangement. Also, the image processing device 10 may record image data generated by the correction on an external or internal recording device.

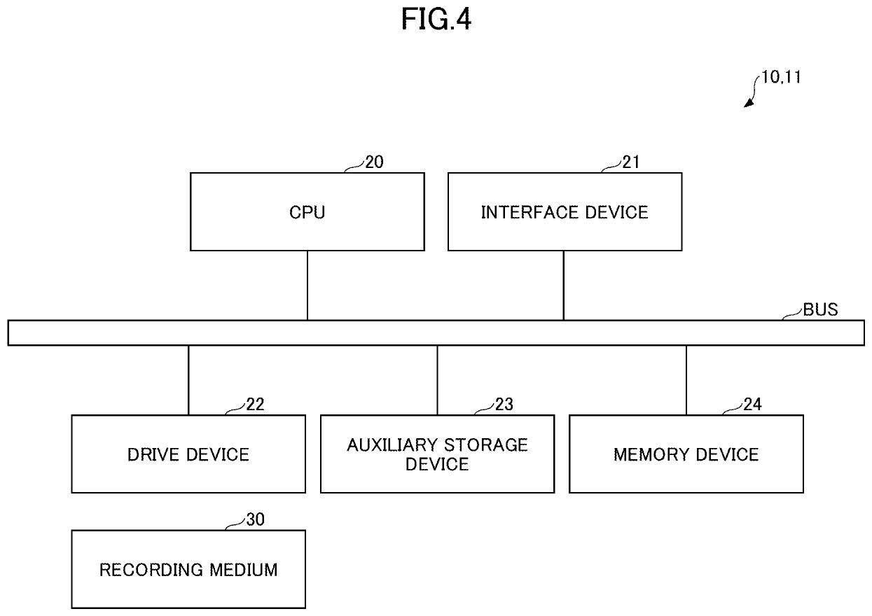

FIG. 4 illustrates an example of a configuration of the image processing device 10 and the information processing device 11 in FIG. 3. The configurations of the image processing device 10 and the information processing device 11 are similar to each other; therefore, in the following, the configuration of the image processing device 10 will be described. For example, the image processing device 10 includes a CPU 20, an interface device 21, a drive device 22, an auxiliary storage device 23, and a memory device 24 that are interconnected by a bus BUS.

The CPU 20 executes various types of image processing as will be described later, by executing an image processing program stored in the memory device 24. The interface device 21 is used for connecting to a network (not illustrated). The auxiliary storage device 23 is, for example, an HDD (Hard Disk Drive) or an SSD (Solid State Drive), to hold various parameters to be used for the image processing program, image data, and image processing.

The memory device 24 is, for example, a DRAM (Dynamic Random Access Memory), to hold the image processing program or the like transferred from the auxiliary storage device 23. The drive device 22 includes an interface for connecting a recording medium 30, to transfer the image processing program stored in the recording medium 30 to the auxiliary storage device 23, for example, based on instructions from the CPU 20. Note that the drive device 22 may transfer image data or the like stored in the auxiliary storage device 23 to the recording medium 30.

FIG. 5 is an explanatory diagram illustrating an example of converting image data of a QBC arrangement obtained by the imaging device 19 in FIG. 3 to image data of a Bayer arrangement. In the following description, a pixel PX including a filter that transmits red light R will also be referred to as an R pixel. A pixel PX including a filter that transmits green light G will also be referred to as a G pixel. A pixel PX including a filter that transmits blue light B will also be referred to as a B pixel. Also, in image data obtained by the imaging device 19, a pixel value of an R pixel will also be referred to as an R pixel value, a pixel value of a G pixel will also be referred to as a G pixel value, and a pixel value of a B pixel will also be referred to as a B pixel value.

A QBC arrangement has a basic arrangement of 16 pixels of four vertical pixels by four horizontal pixels, in which an R pixel group including four R pixels of two vertical pixels by two horizontal pixels; two G pixel groups each including four G pixels of two vertical pixels by two horizontal pixels; and a B pixel group including four B pixels of two vertical pixels by two horizontal pixels, are arranged. In the basic arrangement, the R pixel group and the B pixel group is arranged at diagonal positions, and the two G pixel groups are arranged at diagonal positions.

In addition, in the QBC arrangement, the basic arrangement of 16 pixels is arranged repeatedly in the vertical direction and the horizontal direction, and the R pixel groups, the G pixel groups, and the B pixel groups are arranged in a Bayer arrangement. In the following, image data of a QBC arrangement will also be referred to as a QBC image, and image data of a Bayer arrangement will also be referred to as a Bayer image.

The image processing device 10 generates each pixel value of a Bayer image, by executing an interpolation process using the pixel values of pixels of a QBC image. When outputting a Bayer image converted from a QBC image, the image is output as a full-size output or a binning output. In the full-size output, a Bayer image having the number of pixels that is the same as the number of pixels of the QBC image is generated. In the binning output, a Bayer image is generated in which the number of pixels is compressed to a quarter of the number of pixels of the QBC image.

In the binning output, each pixel group of the QBC image is treated as one pixel. In the binning output, the pixel values of four pixels are output as the pixel value of one pixel; therefore, noise can be reduced to increase the sensitivity, for example, the resolution can be improved when the illuminance is low. Note that RAW output, that outputs a QBC image as is, is also a full-size output.

In the following, processing executed by the image processing device 10 in the case of generating a full-size Bayer image from a QBC image will be described. In the case of converting image data of the QBC arrangement to image data of a Bayer arrangement, first, the image processing device 10 executes direction determination to determine a direction in which change in the pixel value is small by using the image data of the QBC arrangement. Then, based on a result of the direction determination, the image processing device 10 determines pixels to be used for interpolation of a pixel value.

An enlarged view of a Bayer arrangement image illustrated in FIG. 5 indicated with (a) shows an example where, by interpolation of pixel values, figures (artifacts) are generated as connecting lines between multiple lines that extend in one direction and are at specific intervals. The artifacts illustrated in FIG. 5 tend to be generated in the case of interpolating pixel values, for example, based on an incorrect result of direction determination, in the case where the direction determination is not correct due to use of the pixel values of pixels away from the target pixel. In the QBC arrangement, for example, an R pixel positioned around a target R pixel group is away from the target R pixel group by two pixels or more. Therefore, in image data of the QBC arrangement, correction of the pixel values based on direction determination using only pixels of the same color could be a cause of generation of artifacts. Therefore, in the present embodiment, for example, the image processing device 10 uses the G pixels of a G pixel group adjacent to a target R pixel group to execute direction determination, and thereby, improves the precision of direction determination, to suppress generation of artifacts that would be caused by interpolation of the pixel values.

FIG. 6 is a flow chart illustrating an example of a processing flow of converting image data of a QBC arrangement to image data of a Bayer arrangement, executed by the image processing device 10 in FIG. 3. In other words, FIG. 6 illustrates an example of a method of image processing executed by the image processing device 10. The flow illustrated in FIG. 6 may be implemented by, for example, executing an image processing program by the CPU 20 (FIG. 4) of the image processing device 10.

First, at Step S10, the image processing device 10 converts the pixel values at positions of the R pixels and the B pixels of the QBC image to G pixel values, to generate an image of all green pixels in which all pixels are G pixels. The image data of the image of all green pixels is an example of green image data. Step S10 includes Steps S12 and S13. For example, processing shown at Step S12 is executed by the direction determination unit 10b in FIG. 2, and processing shown at Step S13 is executed by the image conversion unit 10c in FIG. 2.

At Step S12, the image processing device 10 executes direction determination at the center of the target R pixel group, by using the pixel values of the G pixels of the G pixel group adjacent to the target R pixel group. Also, the image processing device 10 executes direction determination of the target B pixel group, by using the pixel values of the G pixels of the G pixel group adjacent to the target B pixel group. Then, the image processing device 10 determines a direction in which change in the pixel value is small at each of the center positions of the R pixel group and the B pixel group.

Part of the frequency band of light that can be detected by a G pixel overlaps each of the frequency band of light that can be detected by an R pixel and the frequency band of light that can be detected by a B pixel. Therefore, direction determination by the G pixel value is almost equivalent to executing both direction determination by the R pixel value and direction determination by the B pixel value. Also, in the QBC pixel arrangement, the number of G pixels is twice the number of R pixels and the number of B pixels. Therefore, by executing direction determination using the G pixel value, compared to the case of executing direction determination using the R pixel value or the B pixel value, the precision of direction determination can be improved.

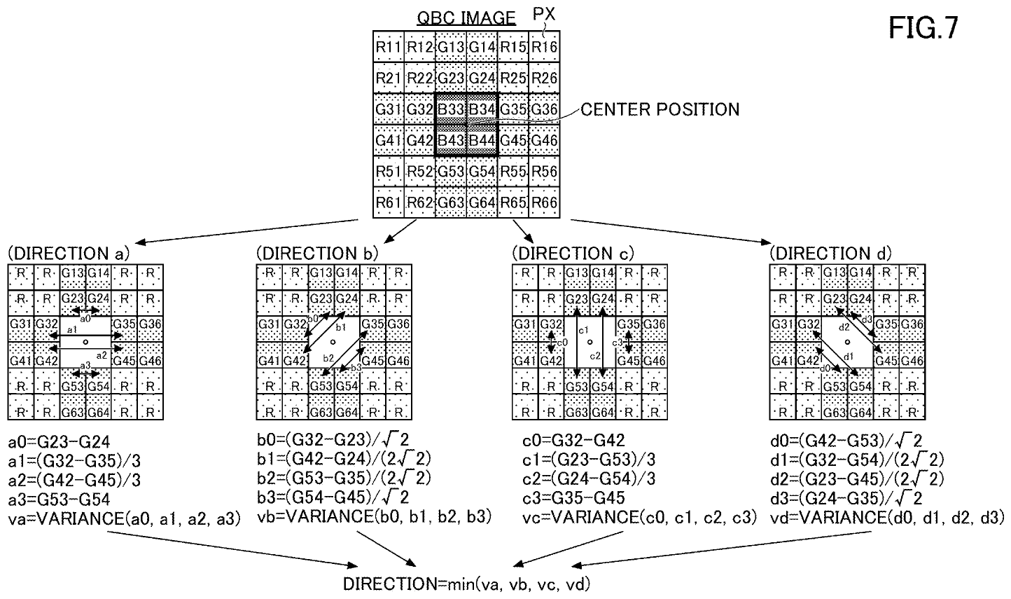

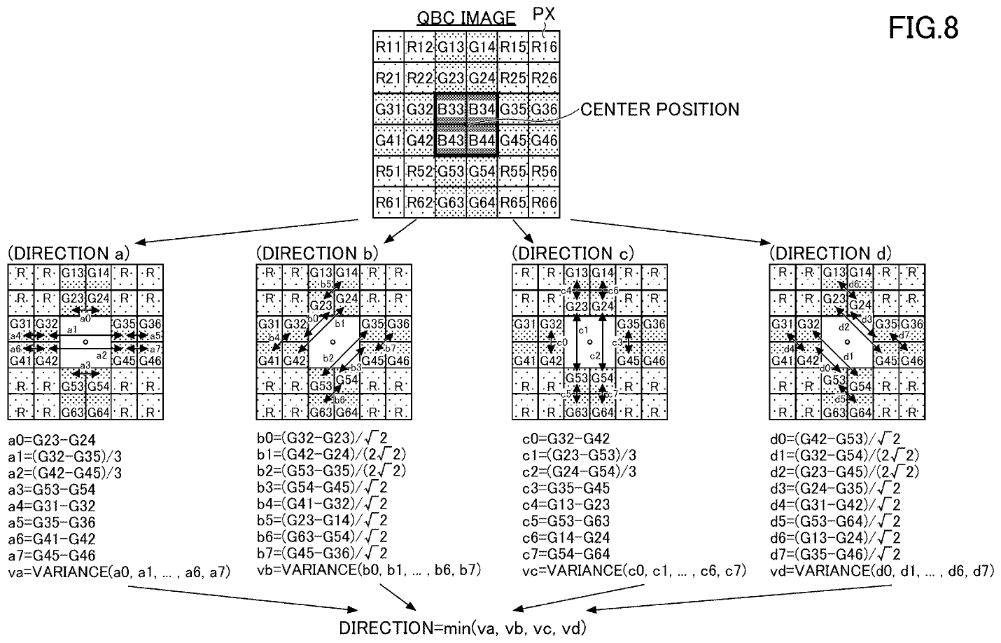

Further, the image processing device 10 does not execute direction determination for each of the four pixels of each pixel group, but executes direction determination for each pixel group, and hence, can efficiently execute direction determination at the positions of the pixel groups with a reduced amount of calculation. Also, as the amount of calculation can be reduced, the circuit size of the image processing device 10 can be reduced. An example of the processing at Step S12 is illustrated in FIGS. 7 and 8.

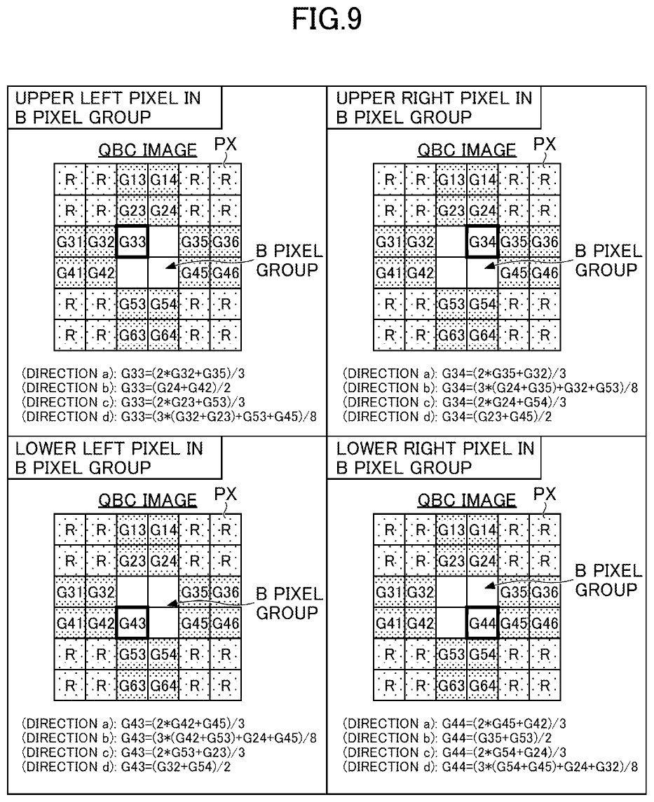

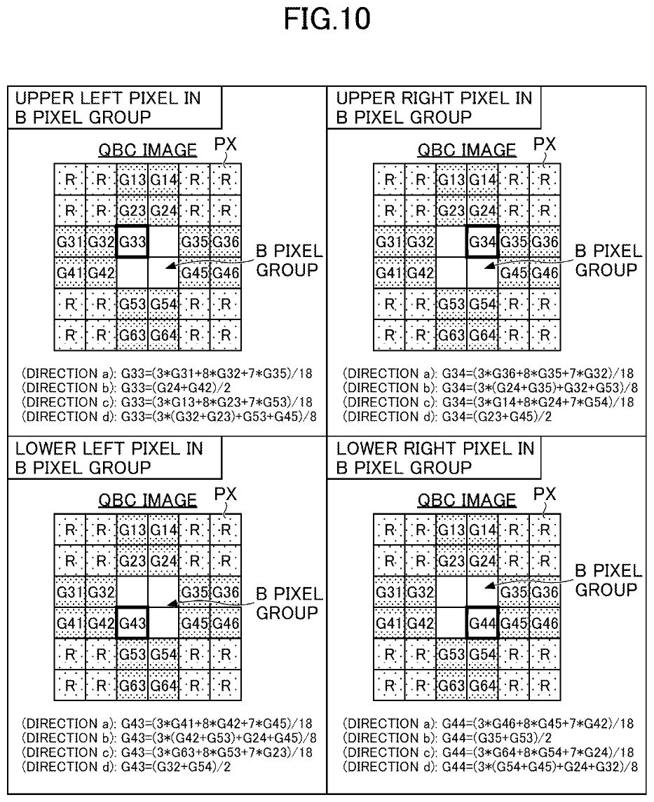

Next, at Step S13, based on a result of direction determination for each pixel group at Step S12, the image processing device 10 executes a process of replacing each pixel of the R pixel group and the B pixel group with a G pixel by an interpolation process. Then, the image processing device 10 generates an image of all green pixels from the QBC image. An example of the processing at Step S13 is illustrated in FIGS. 9 and 10.

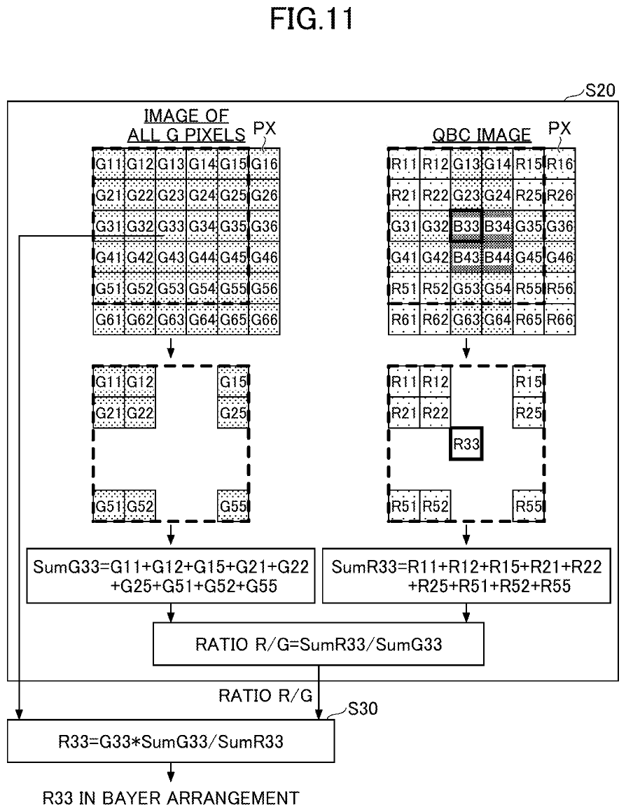

Next, at Step S20, the image processing device 10 calculates a ratio R/G of R pixels in the QBC arrangement positioned around an R pixel in the Bayer arrangement in which the pixel values have been interpolated (surrounding R pixels), to G pixels at the same positions as the surrounding R pixels in the image of all green pixels (surrounding G pixels). Also, the image processing device 10 calculates a ratio B/G of B pixels in the QBC arrangement positioned around a B pixel in the Bayer arrangement in which the pixel values have been interpolated (surrounding B pixels), to G pixels at the same positions as the surrounding B pixels in the image of all green pixels (surrounding G pixels). An example of the processing at Step S20 is illustrated in FIG. 11. The processing at Step S20 is executed by the image conversion unit 10c in FIG. 2.

Next, at Step S30, the image processing device 10 calculates the pixel value of the R pixel by multiplying the ratio R/G corresponding to the target R pixel in the Bayer arrangement, by the pixel value of the G pixel of the image of all green pixels corresponding to the target R pixel. The symbol ‘*’ in a formula in the frame of Step S30 denotes a multiplication sign. The image processing device 10 calculates the pixel value of the B pixel by multiplying the ratio B/G corresponding to the target B pixel in the Bayer arrangement, by the pixel value of the G pixel of the image of all green pixels corresponding to the target B pixel.

Then, the image processing device 10 generates a Bayer image, by extracting the G pixels of the Bayer arrangement from the image of all green pixels and using the extracted G pixels, the calculated R pixels and B pixels. An example of the processing at Step S30 is illustrated in FIG. 11. The processing at Step S30 is executed by the image conversion unit 10c in FIG. 2.

As illustrated in FIG. 6, the image processing device 10 can generate from a QBC image a Bayer image having a pixel arrangement different from that of the QBC image. At this time, the image processing device 10 uses pixel values of G pixels of G pixel groups around a target pixel group to execute direction determination, and thereby, generation of artifacts can be suppressed when converting an image.

FIG. 7 is an explanatory diagram illustrating an example of a process executed at Step S12 in FIG. 6. In FIG. 7, in order to make the description easier to understand, serial numbers are assigned to pixels in each group of R pixels, G pixels, and B pixels of the QBC image. In the example illustrated in FIG. 7, the image processing device 10 executes direction determination at the center position of a target B pixel group or R pixel group, using changed amounts of G pixel values of multiple pairs of pixels along four directions of direction a, direction b, direction c, and direction d. By calculating the multiple changed amounts of the G pixel values of pairs of pixels along the four directions a, b, c, and d, the image processing device 10 can select a direction in which change in the pixel value is small in the target pixel group, from among the four directions. Note that in FIG. 7, although an example is illustrated in which the target pixel group is a B pixel group, in the case where the target pixel group is an R pixel group, the R pixel and the B pixel in FIG. 7 are interchanged.

The direction a is a horizontal direction in FIG. 7, and is an example of an arrangement direction of pixels. The direction b is a diagonal direction from the lower left to the upper right in FIG. 7. The direction c is a vertical direction in FIG. 7, and is an example of a direction orthogonal to the arrangement direction of pixels. The direction d is a diagonal direction from the upper left to the lower right in FIG. 7, and is an example of a direction orthogonal to the direction b. Upon direction determination, the image processing device 10 uses pixel values of eight G pixels adjacent to the top, bottom, left, and right of the target B pixel group or R pixel group, to detect the changed amount of the G pixel value in each of the directions a, b, c, and d. Note that a difference described below is an absolute value that represents the changed amount of the pixel value.

By using the pixel values of pixels adjacent to the target pixel group, the image processing device 10 can execute direction determination using a changed amount of the pixel value that is close to the tendency of the changed amount of the pixel value within the target pixel group. Accordingly, compared to the case of executing direction determination by using the pixel values of pixels away from the target pixel, the image processing device 10 can improve the precision of the direction determination at the position of the target pixel group.

In the direction a, the image processing device 10 calculates a difference a0 between the pixel values G23 and G24; a difference a1 obtained by dividing the difference between the pixel values G32 and G35 by a distance of 3; a difference a2 obtained by dividing the difference between the pixel values G42 and G45 by a distance of 3; and a difference a3 between the pixel values G53 and G54. By varying the weight according to the distance between the pixels of the pair of pixels (distance of 1 or distance of 3), the image processing device 10 can calculate the differences a0, a1, a2, and a3 that indicate slopes of the changed amounts. Next, the image processing device 10 calculates a variance va in the direction a of the target center position of the pixel group from the differences a0, a1, a2, and a3 that indicate the slopes of the changed amounts.

In the direction b, the image processing device 10 calculates a difference b0 obtained by dividing the difference between the pixel values G32 and G23 by the square root of two; and a difference b1 obtained by dividing the difference between the pixel values G42 and G24 by two times the square root of two. Also, the image processing device 10 calculates a difference b2 obtained by dividing the difference between the pixel values G53 and G35 by two times the square root of two; and a difference b3 obtained by dividing the difference between the pixel values G54 and G45 by the square root of two. Next, the image processing device 10 calculates a variance vb in the direction b of the target center position of the pixel group from the differences b0, b1, b2, and b3 that indicate the slopes of the changed amounts.

In the direction c, the image processing device 10 calculates a difference c0 between the pixel values G32 and G42; a difference c1 obtained by dividing the difference between the pixel values G23 and G53 by a distance 3; a difference c2 obtained by dividing the difference between the pixel values G24 and G54 by a distance 3; and a difference c3 in the pixel values G35 and G45. Next, the image processing device 10 calculates a variance vc in the direction c of the target center position of the pixel group from the differences c0, c1, c2, and c3 that indicate the slopes of the changed amounts.

In the direction d, the image processing device 10 calculates a difference d0 obtained by dividing the difference between the pixel values G42 and G53 by the square root of two; and a difference d1 obtained by dividing the difference between the pixel values G32 and G54 by two times the square root of two. Also, the image processing device 10 calculates a difference d2 obtained by dividing the difference between the pixel values G23 and G45 by two times the square root of two; and a difference d3 obtained by dividing the difference between the pixel values G24 and G35 by the square root of two. Next, the image processing device 10 calculates a variance vd in the direction d of the target center position of the pixel group from the differences d0, d1, d2, and d3 that indicate the slopes of the changed amounts.

Then, the image processing device 10 detects the smallest value from among the variances va, vb, vc, and vd, to determine a direction corresponding to the detected value as the direction in which change in the pixel value is the smallest. By using the variances, the image processing device 10 can statistically determine the direction in which change in the pixel value is the smallest. Also, for example, each of the pairs of pixels for calculating the differences a1, a2, b1, b2, c1, c2, d1, and d2 are arranged at positions across the target pixel group. Accordingly, at the center position of the pixel group having no component of a G pixel value, the precision of direction determination can be improved.

Note that the image processing device 10 may accumulate the differences between the pixel values of the pairs of pixels in each of the directions a, b, c, and d, to determine that a direction in which the accumulated value is the smallest is the direction in which change in the pixel value is the smallest. In the case of determining the direction by the total value of the differences between two pixel values of the pairs of pixels, the amount of calculation can be reduced compared to the case of calculating the variances.

Also, the image processing device 10 may calculate changed amounts of the pixel values of the pairs of pixels included in the pixel group, for each of the four pixel groups adjacent to the target pixel group in the upward, downward, leftward, and rightward directions, to detect a direction in which change in the pixel value is the smallest, based on the calculation result. In other words, the image processing device 10 may select a pair of pixels that are not across the target pixel group.

In this case, for example, the image processing device 10 calculates in the direction a, a changed amount of the pixel values G31 and G32, a changed amount of the pixel values G41 and G42, a changed amount of the pixel values G35 and G36, and a changed amount of the pixel values G45 and G46. The image processing device 10 calculates in the direction b, a changed amount of the pixel values G41 and G32, a changed amount of the pixel values G45 and G36, a changed amount of the pixel values G23 and G14, and a changed amount of the pixel values G63 and G54.

The image processing device 10 calculates in the direction c, a changed amount of the pixel values G13 and G23, a changed amount of the pixel values G14 and G24, a changed amount of the pixel values G53 and G63, and a changed amount of the pixel values G54 and G64. The image processing device 10 calculates in the direction d, a changed amount of the pixel values G31 and G42, a changed amount of the pixel values G35 and G46, a changed amount of the pixel values G13 and G24, and a changed amount of the pixel values G53 and G64.

Also, the image processing device 10 may execute direction determination, by using, in addition to the changed amounts of the pixel values of the pairs of pixels used for the direction determination illustrated in FIG. 7, changed amounts of the pixel values of the pairs of pixels included in the four pixel groups.

Further, the image processing device 10 may add the changed amounts of the pixel values of the pairs of pixels of the four pixel groups positioned in the diagonal directions of the target pixel group, to the process of direction determination illustrated in FIG. 7. In this case, the image processing device 10 uses four R pixel groups positioned in the diagonal directions of the target B pixel group for the direction determination, and uses four B pixel groups positioned in the diagonal directions of the target R pixel group for the direction determination.

FIG. 8 is an explanatory diagram illustrating another example of a process executed at Step S12 in FIG. 6. Detailed descriptions of elements and steps similar to those in FIG. 7 are omitted. In FIG. 8, upon direction determination, the image processing device 10 uses pixel values of eight G pixels adjacent to the top, bottom, left, and right of the target R pixel group or the G pixel group, and pixel values of eight G pixels positioned further outward, to detect changes in the G pixel value in the directions a, b, c, and d. The differences a0 to a3, b0 to b3, c0 to c3, and d0 to d3 are calculated by substantially the same method as in FIG. 7.

In the direction a, the image processing device 10 further calculates a difference a4 between the pixel values G31 and G32; a difference a5 between the pixel values G35 and G36; a difference a6 between the pixel values G41 and G42; and a difference a7 between the pixel values G45 and G46. Then, by calculating the variance of the differences a0, a1, a2, a3, a4, a5, a6, and a7, the image processing device 10 calculates a variance va in the horizontal direction at the center position of the target pixel group.

In the direction b, the image processing device 10 further calculates a difference b4 obtained by dividing the difference between the pixel values G41 and G32 by the square root of two; and a difference b5 obtained by dividing the difference between the pixel values G23 and G14 by the square root of two. Also, the image processing device 10 calculates a difference b6 obtained by dividing the difference between the pixel values G63 and G54 by the square root of two; and a difference b7 obtained by dividing the difference between the pixel values G45 and G36 by the square root of two. Then, by calculating the variance of the differences b0, b1, b2, b3, b4, b5, b6, and b7, the image processing device 10 calculates a variance vb in the horizontal direction at the center position of the target pixel group.

In the direction c, the image processing device 10 further calculates a difference c4 of the pixel values G13 and G23; a difference c5 in the pixel values G53 and G63; a difference c6 between the pixel values G14 and G24; and a difference c7 in the pixel values G54 and G64. Then, by calculating the variance of the differences c0, c1, c2, c3, c4, c5, c6, and c7, the image processing device 10 calculates a variance vc in the horizontal direction at the center position of the target pixel group.

In the direction d, the image processing device 10 further calculates a difference d4 obtained by dividing the difference between the pixel values G31 and G42 by the square root of two; and a difference d5 obtained by dividing the difference between the pixel values G53 and G64 by the square root of two. Also, the image processing device 10 calculates a difference d6 obtained by dividing the difference between the pixel values G13 and G24 by the square root of two; and a difference d7 obtained by dividing the difference between the pixel values G35 and G46 by the square root of two. Then, by calculating the variance of the differences d0, d1, d2, d3, d4, d5, d6, and d7, the image processing device 10 calculates a variance vd in the horizontal direction at the center position of the target pixel group.

Then, in substantially the same way as in FIG. 7, the image processing device 10 detects the smallest value from among the variances va, vb, vc, and vd, to determine the direction corresponding to the detected value as the direction of the edge. Also in FIG. 8, by using the variances, the image processing device 10 can statistically determine the direction in which change in the pixel value is the smallest.

In FIG. 8, the image processing device 10 can increase the number of changed amounts of the pairs of pixels used for direction determination, by executing direction determination using not only the pixel values of pixels adjacent to the target pixel group, but also the pixel values of pixels positioned further outward. Accordingly, the image processing device 10 can improve the precision of direction determination at the position of the target pixel group.

Note that the image processing device 10 may accumulate the differences between the pixel values of the pairs of pixels in the directions without calculating the variances, to determine that the direction in which the accumulated value is small is the direction in which change in the pixel value is the smallest. In this case, compared to the case of calculating the variances, the amount of calculation can be reduced. Also, the image processing device 10 may further increase the number of pairs of pixels of the G pixel groups for calculating the changed amount of the pixel value as compared to FIG. 8. At this time, the image processing device 10 may select only pairs of pixels that are not across the target pixel group. Also, the image processing device 10 may add the changed amounts of the pixel values of the pairs of pixels of the four pixel groups positioned in the diagonal directions of the target pixel group, to the process of direction determination illustrated in FIG. 8.

Note that in FIGS. 7 and 8, although the image processing device 10 determines a direction in which change in the pixel value is small based on the changed amount of the pixel values in each of the four directions a, b, c, and d, a direction in which change in the pixel value is small may be determined based on the changed amounts of the pixel values in eight directions or 16 directions. Although the amount of calculation increases as the number of directions increases, the precision of direction determination can be improved.

FIG. 9 is an explanatory diagram illustrating an example of a process executed at Step S13 in FIG. 6. Based on the direction determined as in FIG. 7 or FIG. 8, in the QBC image, the image processing device 10 executes a process of replacing four B pixels of each B pixel group with G pixels, and a process of replacing four R pixels of each R pixel group with G pixels. In the following, although the process of replacing each B pixel of a B pixel group with a G pixel will be described, the process of replacing each R pixel of an R pixel group with a G pixel is also executed using substantially the same formulas as described in FIG. 9.

In the case of replacing each R pixel of an R pixel group with a G pixel, from among G pixels positioned around the target pixel, by using G pixels along the direction of the edge determined as in FIG. 7 or FIG. 8, the image processing device 10 calculates the G pixel value to be replaced. In the following, an example of replacing a B pixel at the upper left of the B pixel group on the upper left side in FIG. 9 with a G pixel (G33) will be described.

In the case where the determined edge is in the direction a, the image processing device 10 sets the pixel value G33 with a value obtained by dividing by three a sum of twice the pixel value of the pixel G32 adjacent on the left side, and the pixel value of the pixel G35 one pixel away on the right side. In the case where the determined edge is in the direction b, the image processing device 10 sets the pixel value G33 with a value obtained by dividing by two a sum of the pixel value of the pixel G24 on the upper right side and the pixel value of the pixel G42 on the lower left side.

In the case where the determined edge is in the direction c, the image processing device 10 sets the pixel value G33 with a value obtained by dividing by three a sum of twice the pixel value of the pixel G23 adjacent on the upper side, and the pixel value of the pixel G53 one pixel away on the lower side. In the case where the determined edge is in the direction d, the image processing device 10 first calculates three times a sum of the pixel value of the pixel G32 adjacent on the left side and the pixel value of the pixel G23 adjacent on the upper side. Then, the image processing device 10 sets the pixel value G33 with a value obtained by dividing by 8 a sum of the threefold pixel value as above, the pixel value of the pixel G53 one pixel away on the lower side, and the pixel value of the pixel G45 approximately one pixel away on the lower right side.

For each of the other pixel values of the B pixels of the B pixel group, a G pixel value is also calculated as described above using formulas depending on the direction of the determined edge. The calculation of replacing the pixel value of the upper right B pixel of the B pixel group with the G pixel value (G34) is shown in the upper right formulas in FIG. 9. The calculation of replacing the pixel value of the lower left B pixel of the B pixel group with the G pixel value (G43) is shown in the lower left formulas in FIG. 9. The calculation of replacing the pixel value of the lower right B pixel of the B pixel group with the G pixel value (G44) is shown in the lower right formulas in FIG. 9.

FIG. 10 is an explanatory diagram illustrating another example of a process executed at Step S13 in FIG. 6. Detailed description is omitted for substantially the same processing as in FIG. 9. In the example illustrated in FIG. 10, the image processing device 10 calculates the pixel value of a G pixel to be replaced from a B pixel, by using not only a G pixel that is adjacent to the G pixel group, but also a G pixel further outward by one pixel with respect to the G pixel adjacent to the G pixel group. Note that the process of replacing each R pixel of an R pixel group with a G pixel is also executed using substantially the same formulas as illustrated in FIG. 10.

In the following, an example of replacing a B pixel at the upper left of the G pixel group on the upper left side with a G pixel (G33) will be described. In the case where the determined edge is in the direction a, the image processing device 10 sets the pixel value G33 with a value obtained by dividing by 18 a sum of three times the pixel value of the pixel G31 away on the left side by one pixel, eight times the pixel value of the pixel G32 adjacent on the left side, and seven times the pixel value of the pixel G35 away on the right side by one pixel. In the case where the determined edge is in the direction b, the image processing device 10 sets the pixel value G33 with a value obtained by dividing by two a sum of the pixel value of the pixel G24 adjacent on the upper right side and the pixel value of the pixel G42 adjacent on the lower left side.

In the case where the determined edge is in the direction c, the image processing device 10 sets the pixel value G33 with a value obtained by dividing by 18 a sum of three times the pixel value of the pixel G13 away on the upper side by one pixel, eight times the pixel value of the pixel G23 adjacent on the upper side, and seven times the pixel value of the pixel G53 away on the lower side by one pixel. In the case where the determined edge is in the direction d, the image processing device 10 uses the same formula for the direction d illustrated in FIG. 9, to calculate the pixel G33.

For each of the other pixel values of the B pixels of the B pixel group, the G pixel value is also calculated as described above using formulas depending on the direction of the determined edge. The calculation of replacing the pixel value of the upper right B pixel of the B pixel group with the G pixel value (G34) is shown in the upper right formulas in FIG. 10. The calculation of replacing the pixel value of the lower left B pixel of the B pixel group with the G pixel value (G43) is shown in the lower left formulas in FIG. 10. The calculation of replacing the pixel value of the lower right B pixel of the B pixel group with the G pixel value (G44) is shown in the lower right formulas in FIG. 10.

In FIGS. 9 and 10, the image processing device 10 uses the pixel values of the G pixel groups adjacent to the B pixel group or the R pixel group, to calculate the pixel value of the G pixel that replaces the B pixel or the R pixel. Therefore, the image processing device 10 can calculate the G pixel value more precisely, compared to the case of calculating a G pixel value to be replaced from a B pixel or an R pixel using a pixel value of the G pixel group not adjacent to the B pixel group or the R pixel group. Also, the image processing device 10 converts each pixel of the B pixel group and the R pixel group to a G pixel, and does not convert a G pixel of the QBC image. Therefore, increase of the amount of calculation to generate an image of all green pixels can be suppressed.

FIG. 11 is an explanatory diagram illustrating an example of processing executed at Steps S20 and S30 in FIG. 6. At Step S20 illustrated in FIG. 11, in a QBC image, an example is shown in which a ratio R/G is calculated by using 25 pixels of five vertical pixels by five horizontal pixels, for the pixel R33 at the center of the 25 pixels of a Bayer arrangement as indicated by a bold dashed frame. Here, the pixel B33 of the QBC image is converted to the pixel R33 in the Bayer arrangement.

At Step S20, the image processing device 10 calculates a sum SumR33 by adding the pixel values of pixels R11, R12, R15, R21, R22, R25, R51, R52, and R55 in the same color as the pixel R33 to be generated by interpolation, from among the 25 pixels of the QBC image. The pixel R33 is an example of a converted pixel. Also, in the image of all green pixels, the image processing device 10 calculates a sum SumG33 by adding the pixel values of pixels G11, G12, G15, G21, G22, G25, G51, G52, and G55 that are at the same positions as the R pixels added with the pixel values. Next, the image processing device 10 calculates a ratio R/G by dividing the sum SumR33 by the sum SumG33.

Then, the image processing device 10 calculates at Step S30 the pixel value of the pixel R33 by multiplying the ratio R/G of the pixel R33 calculated at Step S20 by the pixel value G33 of the pixel at the corresponding position in the image of all green pixels. Note that the image processing device 10 shifts the positions of the 25 pixels to execute Step S20, calculates a sum SumR and a sum SumG, and calculates a ratio R/G. Then, the image processing device 10 executes Step S30, and by multiplying the pixel value of the G pixel corresponding by the ratio R/G, calculates the pixel value of the R pixel in the Bayer arrangement.

The image processing device 10 applies the processing illustrated in FIG. 11 not only to the pixels of the QBC image that are going to become B pixels in the Bayer arrangement, but also to the pixels of the QBC image that are going to become R pixels in the Bayer arrangement. In this case, the image processing device 10 calculates a sum SumB by adding the pixel values of the pixels in the same color as the B pixel to be interpolated, from among the 25 pixels of the QBC image. Then, the image processing device 10 calculates a ratio R/G for each pixel of the QBC image that is going to become a B pixel in the Bayer arrangement.

Note that in the case of calculating a sum SumR and a sum SumB, the image processing device 10 may give weights to the pixel values depending on the distance from the target pixel. In this case, the image processing device 10 sets a greater weight to the pixel value of a pixel closer to the target pixel.

For example, in the case of interpolating the pixel R33 based on the pixel values of pixels of the same color as the pixel R33 to be interpolated, from among 25 pixels, depending on the position of the target pixel to be interpolated, the number of pixels having the same color in the 25 pixels varies, and the distance from the target pixel varies. Accordingly, the resolution of the pixel value varies depending on the position of the target pixel to be interpolated, and unevenness in color may be generated. In contrast, in the interpolation method at Step S20, by using an image of all green pixels having a uniform pixel value that has been generated based on a G pixel value of a higher resolution than an R pixel value and a B pixel value, generation of unevenness in color can be suppressed in the image after being converted to the Bayer arrangement.

Note that it is favorable that the image processing device 10 interpolates the pixel value using the method at Step S20, for example, also for R pixels and B pixels that have the same pixel positions in the QBC image and in the Bayer image. Accordingly, the problem of the variation between the pixel values of interpolated pixels and the pixel values of non-interpolated pixels can be solved.

As above, in the present embodiment, for image data of a QBC arrangement or the like in which R pixel groups, G pixel groups, and B pixel groups are arranged repeatedly, a direction in which change in the pixel value is small can be determined appropriately.

By using the pixel values of pixels adjacent to a target pixel group, the image processing device 10 can execute direction determination using changed amounts of the pixel values that are close to a tendency of the changed amount of the pixel value within the target pixel group. Accordingly, compared to the case of executing direction determination by using the pixel values of pixels away from the target pixel, the image processing device 10 can improve the precision of the direction determination at the position of the target pixel group.

The image processing device 10 can increase the number of changed amounts of the pairs of pixels used for direction determination, by executing direction determination using not only the pixel values of pixels adjacent to the target pixel group, but also the pixel values of pixels positioned further outward. Accordingly, the image processing device 10 can improve the precision of direction determination at the position of the target pixel group.

As the image processing device 10 determines the direction based on differences of the pixel values of pairs of pixels arranged at positions across the target pixel group, the precision of direction determination can be improved at the center position of the pixel group having no component of a G pixel value. Also, the image processing device 10 determines a direction in which change in the pixel value is small at the center position of the target pixel group, and hence, can efficiently execute direction determination at the positions of the pixel groups with a reduced amount of calculation. The reduced amount of calculation can also reduce the circuit size of the image processing device 10.

The image processing device 10 can reduce the amount of calculation, by accumulating differences of two pixel values of pairs of pixels, to determine that a direction in which the accumulated value is small is the direction in which change in the pixel value is the smallest, compared to the case of determining the direction from variances. Note that by executing direction determination using the variances, the image processing device 10 can statistically determine the direction in which change in the pixel value is the smallest.

By calculating multiple changed amounts of the pixel values of pairs of pixels along each of a vertical direction, a horizontal direction, and two diagonal directions, the image processing device 10 can select a direction in which change in the pixel value is small at the position of the target pixel group, from among the four directions.

The image processing device 10 can generate from a QBC image a Bayer image having a pixel arrangement different from that of the QBC image. At this time, the image processing device 10 uses pixel values of G pixels of a G pixel group around a target pixel group to execute direction determination, and thereby, generation of artifacts can be suppressed when converting an image.

The image processing device 10 executes direction determination in a QBC image by using the pixel values of the G pixels that are more numerous than the R pixel and the B pixels, and thereby, compared to the case of executing direction determination using the R pixel value or the B pixel value, the precision of direction determination can be improved.

By generating an image of all green pixels by an interpolation process of the G pixel value based on a result of direction determination, the precision of the G pixel value generated by the interpolation process can be improved. By calculating the R pixel value and the B pixel value using a ratio R/G and a ratio B/G with the highly accurate G pixel value, generation of artifacts can be suppressed when generating a Bayer image from a QBC image. Also, in the image processing device 10, by using an image of all green pixels having a uniform pixel value that is generated based on the G pixel value of a higher resolution than the R pixel value and the B pixel value, generation of unevenness in color can be suppressed in the image after being converted to the Bayer arrangement.

### Second Embodiment

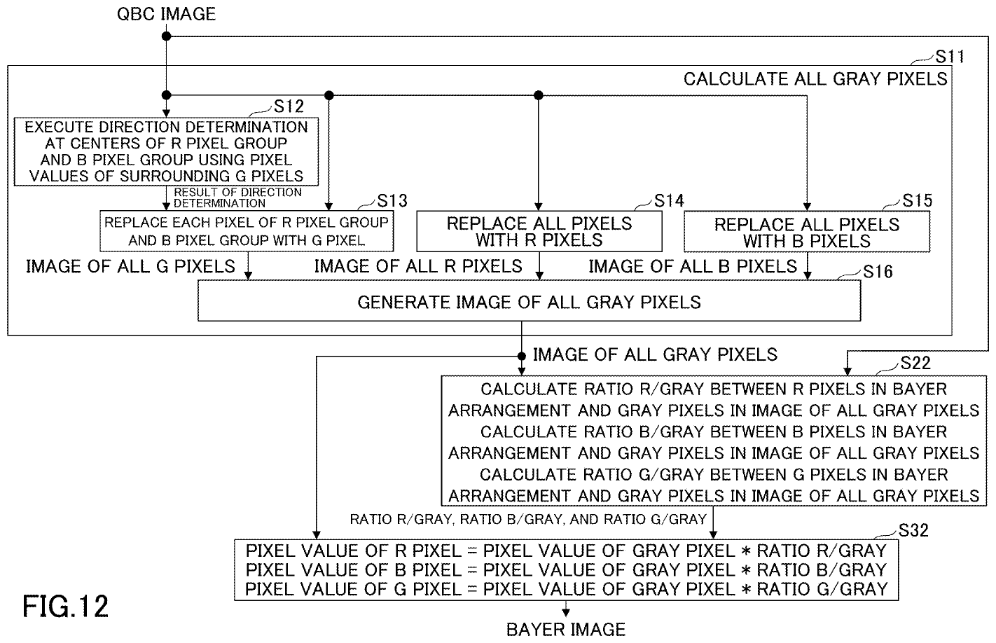

FIG. 12 is a flow chart illustrating an example of a processing flow of converting image data of a QBC arrangement to image data of a Bayer arrangement, executed by an image processing device according to a second embodiment. In other words, FIG. 12 illustrates an example of a method of image processing executed by the image processing device. Detailed description is omitted for substantially the same processing as in FIG. 6.

The image processing device 10 that executes the flow illustrated in FIG. 12 is substantially the same as the image processing device 10 illustrated in FIGS. 1 to 4, and installed in an image processing system 100 with an information processing device 11 and a display device 12. The flow illustrated in FIG. 12 may be implemented by, for example, executing an image processing program by the CPU 20 (FIG. 4) of the image processing device 10 in FIG. 3.

Note that the flow illustrated in FIG. 12 may be implemented by hardware such as an FPGA or an ASIC installed in the image processing device 10s. Alternatively, the flow illustrated in FIG. 12 may be implemented by having hardware and software interoperate.

The image processing system 100 is installed in a mobile body 200 such as an automobile, transfer robot, drone, or the like. Note that the image processing system 100 may be a system that processes images obtained from an imaging device such as a monitoring camera, digital still camera, digital camcorder, or the like.

First, at Step S11, the image processing device 10 generates an image of all gray pixels in which all pixels are gray pixels, from pixels in a QBC image. The image of all gray pixels is an example of combined image data. Here, the pixel value of a gray pixel is generated by combining the pixel values of a pixel R, a pixel G, and a pixel B, and corresponds to a gray color. Step S11 includes Steps S12, S13, S14, S15, and S16. Steps S12 and S13 are substantially the same as Steps S12 and S13 in FIG. 6, respectively. In other words, the image processing device 10 generates an image of all green pixels by processing at Steps S12 and S13.

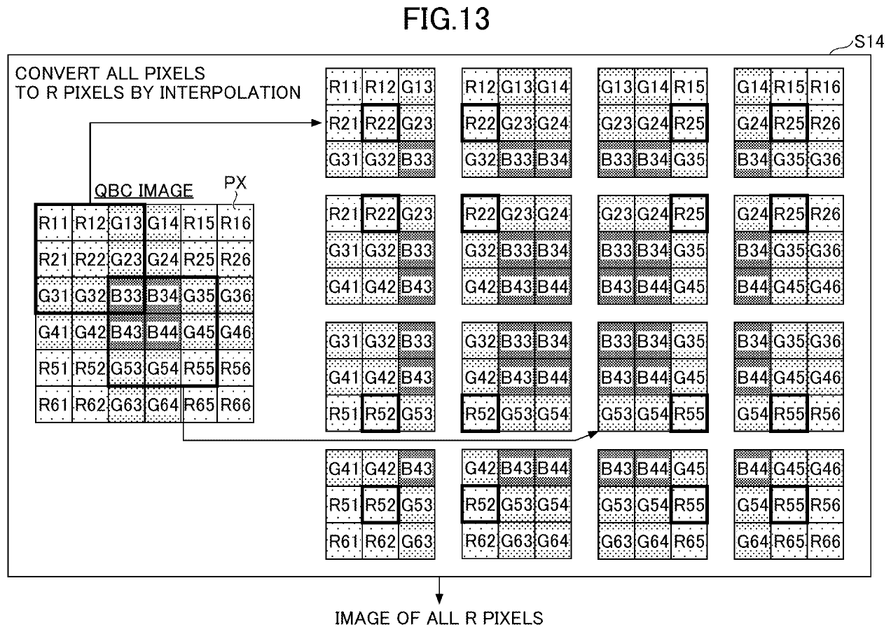

At Step S14, using the QBC image, the image processing device 10 uses R pixels around the position of the target pixel, to execute an interpolation process, and replaces the pixel at the position of the target pixel with an R pixel. Then, the image processing device 10 generates an image of all red pixels in which all pixels are the R pixels, from the QBC image. The image data of the image of all red pixels is an example of red image data. An example of the processing at Step S14 is illustrated in FIG. 13.

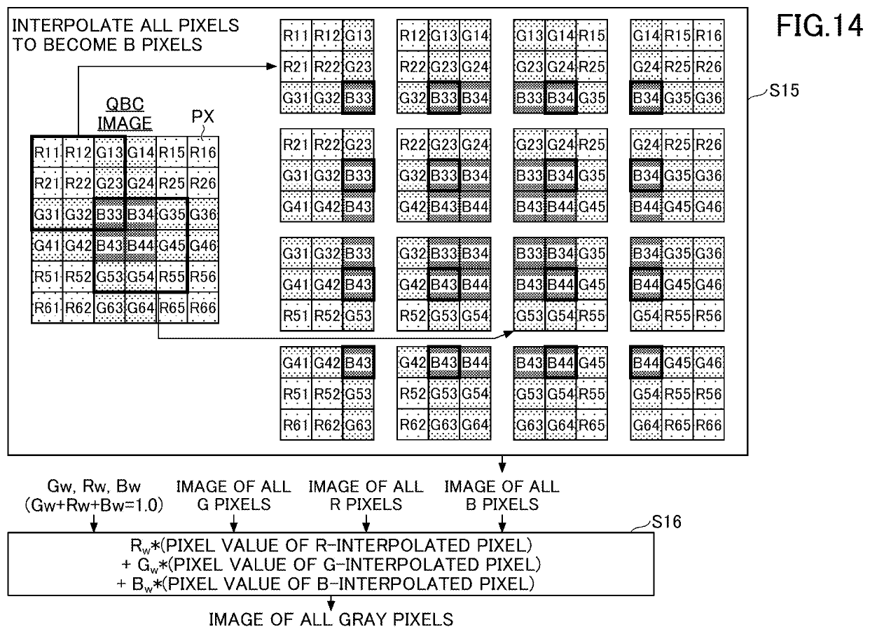

At Step S15, using the QBC image, the image processing device 10 uses B pixels around the position of the target pixel, to execute an interpolation process, and replaces the pixel at the position of the target pixel with a B pixel. Then, the image processing device 10 generates an image of all blue pixels in which all pixels are the B pixels, from the QBC image. The image data of the image of all blue pixels is an example of blue image data. An example of the processing at Step S15 is illustrated in FIG. 14.

Next, at Step S16, the image processing device 10 generates an image of all gray pixels, by combining the pixel value of the image of all green pixels, the pixel value of the image of all red pixels, and the pixel value of the image of all blue pixels by a predetermined ratio, at each pixel position.

Next, at Step S22, the image processing device 10 calculates a ratio R/Gray of R pixels around the position of the target R pixel in the Bayer arrangement (surrounding R pixels), to gray pixels at the same positions as the surrounding R pixels in the image of all gray pixels (surrounding gray pixels). Also, the image processing device 10 calculates a ratio B/Gray of B pixels around the positions of the target B pixel in the Bayer arrangement (surrounding B pixels), to gray pixels at the same positions as the surrounding B pixels in the image of all gray pixels (surrounding gray pixels).

Further, the image processing device 10 calculates a ratio G/Gray of G pixels that are positioned around the target G pixel in the Bayer arrangement (surrounding G pixels), to gray pixels at the same positions as the surrounding G pixels in the image of all gray pixels (surrounding gray pixels). The image processing device 10 executes processing at Step S22 in substantially the same way as at Step S20 in FIG. 11.

Next, at Step S32, the image processing device 10 calculates the R pixel by multiplying the ratio R/Gray corresponding to the target R pixel in the Bayer arrangement, by the gray pixel of the image of all gray pixels corresponding to the target R pixel. The image processing device 10 calculates the B pixel by multiplying the ratio B/Gray corresponding to the target B pixel in the Bayer arrangement, by the gray pixel of the image of all gray pixels corresponding to the target B pixel. Further, the image processing device 10 calculates the G pixel by multiplying the ratio G/Gray corresponding to the target G pixel in the Bayer arrangement, by the gray pixel of the image of all gray pixels corresponding to the target G pixel. Then, the image processing device 10 generates a Bayer image, by the calculated R pixels, B pixels, and G pixels. The image processing device 10 executes processing at Step S22 in substantially the same way as at Step S30 in FIG. 11.

FIG. 13 is an explanatory diagram illustrating an example of a process executed at Step S14 in FIG. 12. In FIG. 13, although 36 pixels of six vertical pixels by six horizontal pixels of a QBC image are shown as an example, the image processing device 10 generates an image of all red pixels, by using all the pixels of the QBC image.

At Step S14, the image processing device 10 sets nine pixels of three vertical pixels by three horizontal pixels as pixels to be used for interpolation, and executes an interpolation process of an R pixel while shifting the positions of the nine pixels one pixel by one pixel. The image processing device 10 generates an image of all red pixels, by setting an R pixel closest to the center of the nine pixels as the R pixel at the center, in the nine pixels. For example, the image processing device 10 sets the pixel value of an R pixel indicated with a bold frame in each of 16 ways of arrangement of nine pixels shown on the right side in FIG. 13, to the pixel value of an R pixel at the center of the 9 pixels.

FIG. 14 is an explanatory diagram illustrating an example of processing executed at Steps S15 and S16 in FIG. 12. Detailed description is omitted for substantially the same processing as in FIG. 13. At Step S15, the image processing device 10 generates an image of all blue pixels, while shifting the positions of nine pixels one pixel by one pixel, by setting a B pixel closest to the center of the nine pixels as the B pixel at the center in the nine pixels. For example, the image processing device 10 sets the pixel value of a B pixel indicated with a bold frame in each of 16 ways of arrangement of nine pixels shown on the right side in FIG. 14, to the pixel value of a B pixel at the center of the nine pixels.

Next, at Step S16, the image processing device 10 generates an image of all gray pixels, by using the image of all green pixels, the image of all red pixels, and the image of all blue pixels at each pixel position. For example, the image processing device 10 multiplies each pixel value of the image of all green pixels by a weight Gw; multiplies each pixel value of the image of all red pixels by a weight Rw; and multiplies each pixel value of the image of all blue pixels by a weight Bw.

For example, the weight Gw is set to 0.8 and the weights R and B are set to 0.1 so as to have the total of the weights being 1.0. Note that although the values of the weights Gw, Rw, and Bw are not limited to those described above, as the components of a G pixel value include not only a green component but also a red component and a blue component, it is favorable that the weight Gw is set to be greater than the weights Rw and Bw. Then, the image processing device 10 generates an image of all gray pixels, by adding the result of multiplication of the G pixel, the R pixel, and the B pixel at each pixel position.

As above, also in this embodiment, the same effects as in the embodiment described above can be obtained. For example, for image data of a QBC arrangement or the like in which R pixel groups, G pixel groups, and B pixel groups are arranged repeatedly, a direction in which change in the pixel value is small can be determined appropriately. Then, by generating an image of all green pixels by an interpolation process of the G pixel value based on a result of direction determination, the precision of G pixel value generated by the interpolation process can be improved.

Further, in this embodiment, the image processing device 10 generates an image of all gray pixels from an image of all green pixels, an image of all red pixels, and an image of all blue pixels, and calculates a ratio R/GRAY, a ratio B/GRAY, and a ratio G/GRAY from the image of all gray pixels. Then, the image processing device 10 generates a Bayer image, by multiplying each of the ratio R/GRAY, ratio B/GRAY, and ratio G/GRAY by the pixel value of each pixel. By using the image of all gray pixels, for example, even in a QBC image having small G pixel values, generation of artifacts can be suppressed when generating a Bayer image from the QBC image.

### Third Embodiment

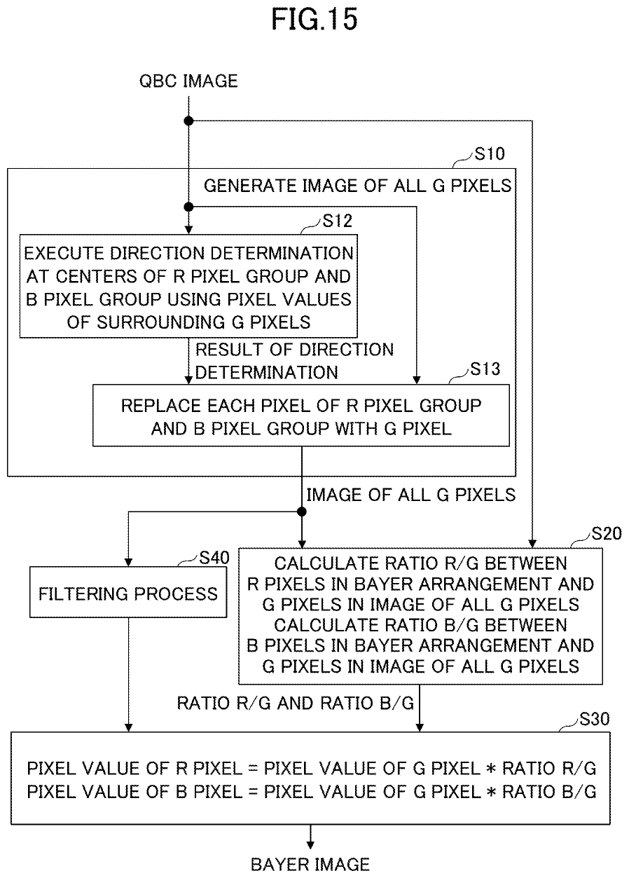

FIG. 15 is a flow chart illustrating an example of a processing flow of converting image data of a QBC arrangement to image data of a Bayer arrangement, executed by an image processing device according to a third embodiment. In other words, FIG. 15 illustrates an example of a method of image processing executed by the image processing device. Detailed description is omitted for substantially the same processing as in FIG. 6.

The image processing device 10 that executes the flow illustrated in FIG. 15 is substantially the same as the image processing device 10 illustrated in FIGS. 1 to 4, and installed in an image processing system 100 with an information processing device 11 and a display device 12. The flow illustrated in FIG. 15 may be implemented by, for example, executing an image processing program by the CPU 20 of the image processing device 10 in FIG. 3.

The processing flow illustrated in FIG. 15 is substantially the same as the processing flow illustrated in FIG. 6, except that Step S40 is added to the processing flow in FIG. 6. Before executing Step S30, at Step S40, the image processing device 10 applies a filtering process to an image of all green pixels. For example, the image processing device 10 may execute, as the filtering process, a noise removal process, an edge enhancing process, or the like, to generate a low-noise image of all green pixels or a high-resolution image of all green pixels. Accordingly, the image processing device 10 can generate a low-noise Bayer image or a high-resolution Bayer image.

As above, also in this embodiment, the same effects as in the embodiments described above can be obtained. Further, in this embodiment, by calculating R pixel values and B pixel values using pixel values of an image of all green pixels to which the filtering process is applied, a low-noise Bayer image or a high-resolution Bayer image can be generated from the QBC image.

### Fourth Embodiment

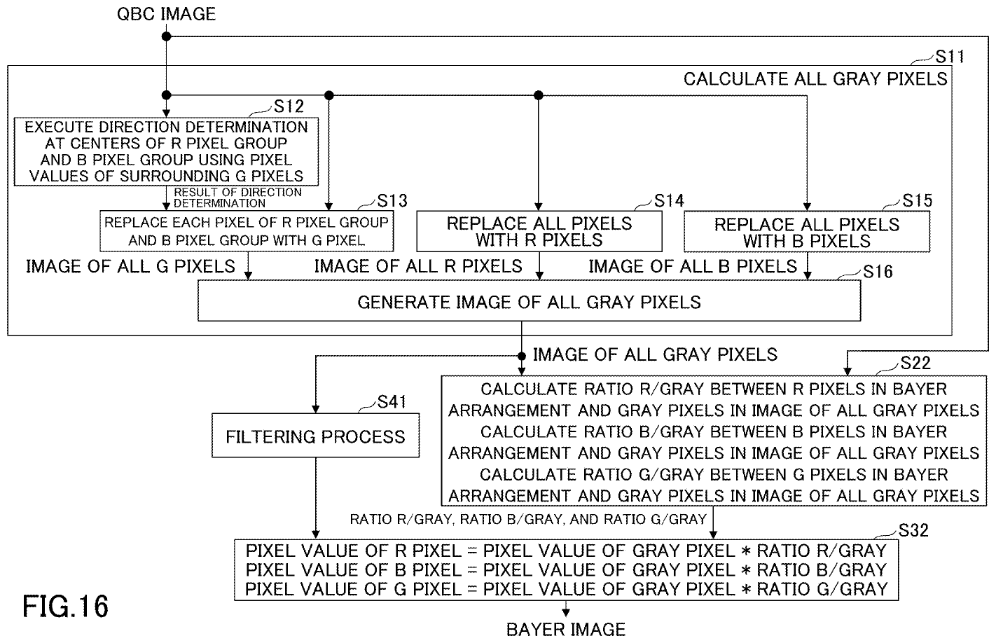

FIG. 16 is a flow chart illustrating an example of a processing flow of converting image data of a QBC arrangement to image data of a Bayer arrangement, executed by an image processing device according to a fourth embodiment. In other words, FIG. 16 illustrates an example of a method of image processing executed by the image processing device. Detailed description is omitted for substantially the same processing as in FIG. 12.

The image processing device 10 that executes the flow illustrated in FIG. 16 is substantially the same as the image processing device 10 illustrated in FIGS. 1 to 4, and installed in an image processing system 100 with an information processing device 11 and a display device 12. The flow illustrated in FIG. 16 may be implemented by, for example, executing an image processing program by the CPU 20 of the image processing device 10 in FIG. 3.

The processing flow illustrated in FIG. 16 is substantially the same as the processing flow illustrated in FIG. 12, except that Step S41 is added to the processing flow in FIG. 12. Before executing Step S32, at Step S41, the image processing device 10 applies a filtering process to an image of all gray pixels. For example, the image processing device 10 may execute, as the filtering process, a noise removal process, an edge enhancing process, or the like, to generate a low-noise image of all gray pixels or a high-resolution image of all green pixels. Accordingly, the image processing device 10 can generate a low-noise Bayer image or a high-resolution Bayer image.

As above, also in this embodiment, the same effects as in the embodiments described above can be obtained. Further, in this embodiment, by calculating R pixel values and B pixel values using pixel values of an image of all gray pixels to which the filtering process is applied, a low-noise Bayer image or a high-resolution Bayer image can be generated from the QBC image.

As above, the present invention has been described based on the respective embodiments; note that the present disclosure is not limited to the requirements set forth in the embodiments described above. These requirements can be changed within a scope not to impair the gist of the present disclosure, and can be suitably defined according to applications.

What is claimed is:

1. An image processing device comprising:
a memory; and
a processor configured to execute obtaining image data from an imaging device in which pixel groups of multiple colors are repeatedly arranged, each of the pixel groups including multiple pixels; and
determining a direction in which change in a pixel value is small at a position of a target pixel group, based on a changed amount of the pixel values of at least one of pairs of pixels that are arranged around the target pixel group, and included in multiple other pixel groups having colors that are different from a color of the target pixel group.

2. The image processing device as claimed in claim 1, wherein the determining determines the direction in which change in the pixel value is small, by using pixel values of pixels adjacent to the target pixel group from among the multiple other pixel groups.

3. The image processing device as claimed in claim 2, wherein the determining determines the direction in which change in the pixel value is small, by further using pixel values of pixels adjacent to the pixels adjacent to the target pixel group from among the multiple other pixel groups.

4. The image processing device as claimed in claim 1, wherein at least one pair from among the pairs of pixels used for determining the direction is arranged at positions across the target pixel group.

5. The image processing device as claimed in claim 1, wherein the determining accumulates differences each calculated between pixel values of the pairs of pixels positioned along each of a plurality of directions, to determine a direction in which an accumulated value is small as the direction in which change in the pixel value is small.

6. The image processing device as claimed in claim 1, wherein the determining calculates variances of slopes of changed amounts of pixel values of the pair of pixels positioned along each of a plurality of directions, to determine a direction in which a calculated variance is small as the direction in which change in the pixel value is small.

7. The image processing device as claimed in claim 5, wherein the plurality of directions include an arrangement direction of pixels, a direction orthogonal to the arrangement direction, a diagonal direction of the arrangement direction, and a direction orthogonal to the diagonal direction.

8. The image processing device as claimed in claim 1, wherein the processor is further configured to execute replacing, based on the direction determined by the determining, at least one of pixels of the target pixel group with a pixel value of a pixel in another color, so as to convert the image data obtained by the imaging device to image data having a pixel arrangement that is different from a pixel arrangement of the imaging device.

9. The image processing device as claimed in claim 8, wherein the replacing converts the image data of a Quad Bayer Coding (QBC) arrangement obtained by the imaging device to the image data of a Bayer arrangement.

10. The image processing device as claimed in claim 9, wherein the determining determines the direction in which change in the pixel value is small at a position of a target red pixel group or a target blue pixel group, based on a changed amount of pixel values of at least one pair of the pairs of pixels included in a green pixel group positioned around the target red pixel group or the target blue pixel group.

11. The image processing device as claimed in claim 9, wherein the determining determines the direction in which change in the pixel value is small at a position of a target red pixel group or a target blue pixel group, based on pixel values of a plurality of green pixel groups arranged around the target red pixel group or the target blue pixel group.

12. A method of image processing executed by an image processing device including a memory and a processor, the method comprising:
obtaining image data from an imaging device in which pixel groups of multiple colors are repeatedly arranged, each of the pixel groups including multiple pixels; and
determining a direction in which change in a pixel value is small at a position of a target pixel group, based on a changed amount of the pixel values of at least one of pairs of pixels that are arranged around the target pixel group, and included in multiple other pixel groups having colors that are different from a color of the target pixel group.
